(19) United States
(12) Patent Application Publication
(10) Pub. No.: US 2014/0110571 A1
(43) Pub. Date: Apr. 24, 2014

(54) MOTION SENSOR AND METHOD OF OPERATING THE SAME

(71) Applicant: Electronics and Telecommunications Research Institute, Daejeon (KR)

(72) Inventors: Hyun-Seok KIM, Daejeon (KR); Tae-Gyu KANG, Daejeon (KR); You-Jin KIM, Daejeon (KR); Dae-Ho KIM, Daejeon (KR); Hyun-Jong KIM, Cheongju-si Chungcheongbuk-do (KR); Seong-Hee PARK, Daejeon (KR); Sang-Kyu LIM, Daejeon (KR); Jung-Sik SUNG, Daejeon (KR); Il-Soon JANG, Daejeon (KR); In-Su KIM, Daejeon (KR); Hyun-Chul KANG, Daejeon (KR); Myung-Soon KIM, Daejeon (KR); Jin-Doo JEONG, Daejeon (KR); Hyun-Joo KANG, Daejeon (KR); Jong-Woo CHOI, Daejeon (KR)

(73) Assignee: Electronics and Telecommunications Research Institute, Daejeon (KR)

(21) Appl. No.: 14/054,252

(22) Filed: Oct. 15, 2013

(30) Foreign Application Priority Data
Oct. 22, 2012 (KR) 10-2012-0117325
Apr. 24, 2013 (KR) 10-2013-0045462

(51) Int. Cl. G01V 8/10

(52) U.S. Cl. CPC G01V 8/10
USPC 250/221

(57) ABSTRACT

The present invention relates to a motion sensor and method of operating the motion sensor, which can adjust the range of a detection area. For this, the motion sensor according to the present invention includes a detection unit for outputting a variation signal corresponding to motion. A threshold level setting unit variably sets at least one changeable threshold level. A comparison unit detects the motion by performing a comparison operation based on the changeable threshold level and the variation signal at threshold sensitivity corresponding to the changeable threshold level.

### CROSS REFERENCE TO RELATED APPLICATIONS

This application claims the benefit of Korean Patent Application Nos. 10-2012-0117325 filed on Oct. 22, 2012 and 10-2013-0045462 filed on Apr. 24, 2013, which are hereby incorporated by reference in their entireties into this application.

### BACKGROUND OF THE INVENTION

1. Technical Field

The present invention relates generally to a motion sensor and method of operating the motion sensor and, more particularly, to a motion sensor and method of operating the motion sensor, which can adjust the range of a detection area.

2. Description of the Related Art

A sensor referred to as a PIR (Pyroelectric Infrared or Passive Infrared) sensor is generally used to detect the presence of a user by controlling energy saving lighting. Such a sensor reacts to a temperature variation occurring depending on the motion of the user in a detection area. That is, when the temperature in the detection area varies due to the body temperature of the user, the operation of the sensor is performed.

Most of such sensors are implemented using a Fresnel lens in which a detection angle is predetermined and a threshold angle is intrinsically set. Accordingly, there is a disadvantage in that, once such a sensor is installed, it is difficult to adjust the detection area. Further, detection using such a sensor is disadvantageous in that it can be only be determined whether a detection target is present in the detection area, and it is difficult to determine detailed movement direction and the exact location of the detection target.

In relation to this technology, Japanese Patent Application Publication No. 2010-237132 discloses technology entitled “Combined monitoring apparatus.”

### SUMMARY OF THE INVENTION

Accordingly, the present invention has been made keeping in mind the above problems occurring in the prior art, and an object of the present invention is to provide a motion sensor and method of operating the motion sensor, which can adjust a detection area.

Another object of the present invention is to reduce the incidence of errors that may occur in a motion sensor and allow a detection device to detect even the direction of motion of a detection target.

In accordance with an aspect of the present invention to accomplish the above objects, there is provided a motion sensor including a detection unit for outputting a variation signal corresponding to motion; a threshold level setting unit for variably setting at least one changeable threshold level; and a comparison unit for detecting the motion by performing a comparison operation based on the changeable threshold level and the variation signal at threshold sensitivity corresponding to the changeable threshold level.

Preferably, the motion sensor may have a detection area varying depending on the threshold sensitivity.

Preferably, the detection area may be widened as the threshold sensitivity increases, whereas the detection area may be narrowed as the threshold sensitivity decreases.

Preferably, the threshold level setting unit may set two or more threshold levels so that an error rate is less than a preset value.

Preferably, the comparison unit may perform digital conversion on the variation signal, generate a digital signal, and compare the digital signal with the changeable threshold level in a digital manner.

Preferably, the digital conversion may be performed by an Analog to Digital (A/D) converter included in a Micro Controller Unit (MCU) or by an independent A/D converter.

Preferably, the threshold level setting unit may set the changeable threshold level through a Digital Addressable Lighting Interface (DALI) or at least one lighting control network interface.

Preferably, the motion sensor may have a detection cycle synchronized with an OFF period of a duty cycle of a Pulse Width Modulation (PWM) signal from a Light Emitting Diode (LED) light source.

In accordance with another aspect of the present invention to accomplish the above objects, there is provided a method of operating a motion sensor, including outputting, by a detection unit, a variation signal corresponding to motion; variably setting, by a threshold level setting unit, at least one changeable threshold level; and detecting, by a comparison unit, the motion by performing a comparison operation based on the changeable threshold level and the variation signal at threshold sensitivity corresponding to the changeable threshold level.

Preferably, variably setting the at least one changeable threshold level may be configured to set two or more threshold levels so that an error rate is less than a preset value.

Preferably, the method may further include, after outputting the variation signal, performing digital conversion on the variation signal and generating a digital signal through an A/D converter, wherein detecting the motion may be configured to compare the digital signal with the changeable threshold level in a digital manner, thus detecting the motion.

Preferably, the digital conversion may be performed by an A/D converter included in a Micro Controller Unit (MCU) or by an independently provided A/D converter.

Preferably, variably setting the at least one changeable threshold level may be configured to set the changeable threshold level through a Digital Addressable Lighting Interface (DALI) or at least one lighting control network interface.

Preferably, the motion sensor may have a detection cycle synchronized with an OFF period of a duty cycle of a Pulse Width Modulation (PWM) signal from a Light Emitting Diode (LED) light source.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a motion sensor according to an embodiment of the present invention;

FIG. 2 is a diagram showing an example in which detection areas are adjusted based on a changeable threshold level according to the motion sensor of the present invention;

FIG. 3 is a diagram showing an example of a variation signal output from a detection unit in the example of FIG. 2;

FIG. 4 is a diagram showing an example of the generation of detection areas in the motion sensor according to the present invention;

FIG. 5 is a diagram showing an example of a variation signal output when a detection target is detected in detection areas generated by the motion sensor according to the present invention;

FIG. 6 is a flowchart showing a method of operating the motion sensor according to an embodiment of the present invention; and

FIG. 7 is a flowchart showing a method of operating the motion sensor according to another embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

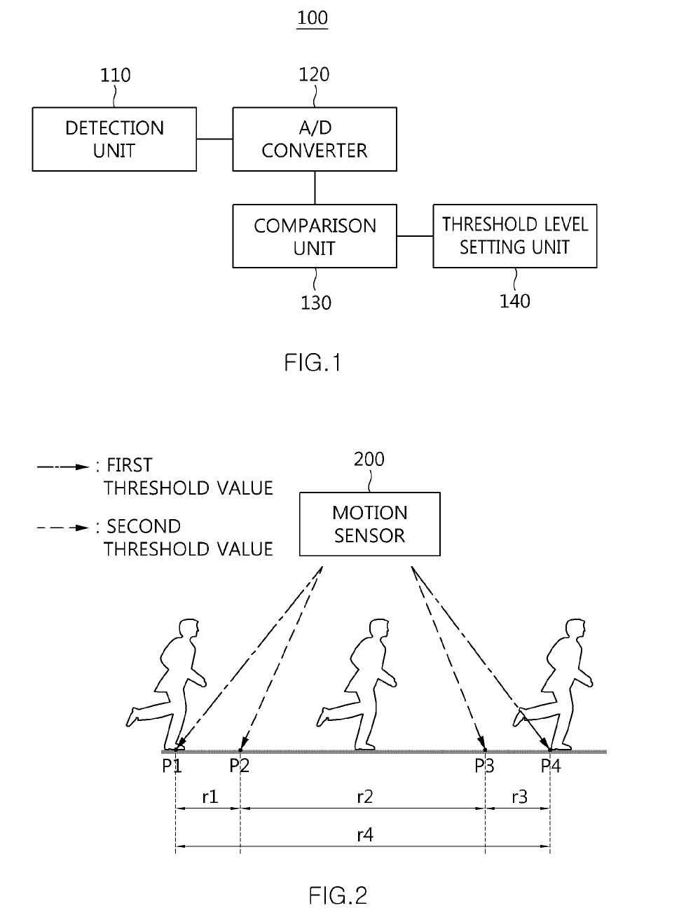

FIG. 1 is a block diagram showing a motion sensor 100 according to an embodiment of the present invention. Referring to FIG. 1, the motion sensor 100 according to the present invention includes a detection unit 110, an Analog to Digital (AID) converter 120, a comparison unit 130, and a threshold level setting unit 140. The components of the motion sensor according to the present invention will be described in detail below.

The detection unit 110 functions to output a variation signal corresponding to motion. That is, the detection unit 110 functions to detect motion when the motion is detected in a detection area. Here, the method of detecting motion may be performed based on a variation in temperature in the detection area by monitoring the detection area. If motion is detected in this way, the detection unit 110 outputs a variation signal corresponding to the motion. Further, the detection unit 110 may perform detection via the sensing of infrared rays emitted from a detection target in the detection area.

For example, it is assumed that the motion sensor 100 according to the present invention is mounted on the ceiling of an indoor space. Then, whether a temperature variation is present in the indoor space may be monitored by the detection unit 110. During this monitoring, if an indoor variation, that is, a variation in indoor temperature caused by the temperature of the detection target, is present, the detection unit 110 may output the variation signal. Here, the variation signal is configured such that the intensity thereof is weakened in a direction from a position opposite to the detection unit 110 to the threshold position of the detection area. That is, as the detection target is detected at a position farther from the detection unit 110, a variation signal having weaker intensity is output. In contrast, as the detection target is detected at a position closer to the detection unit 110, a variation signal having stronger intensity is output. Further, the variation in temperature at the detection position may also influence the intensity of the variation signal.

In this case, the motion sensor 100 according to the present invention may further include a synchronization unit (not shown) to synchronize the OFF period of the duty cycle of a Pulse Width Modulation (PWM) signal of a Light Emitting Diode (LED) light source with the detection cycle of the present invention. That is, in the case of the LED light source, the ON and OFF states of light are alternately repeated at a frequency imperceptible to human eyes. In this case, when the variation signal is output from the detection unit 110, a problem may occur due to light emitted by the LED light source. That is, lighting communication using the LED light source is configured to transmit signals using the flickering of light. In this case, signals may overlap or may cause noise therebetween. Therefore, the detection cycle and the OFF period of the duty cycle are synchronized with each other by the synchronization unit so that the variation signal is output when light is turned off, thus preventing signals between the motion sensor 100 and the LED light source from overlapping each other. By means of this, there is an advantage in that the motion sensor 100 according to the present invention may be mounted together on the LED light source.

The A/D converter 120 functions to convert the variation signal output from the detection unit 110 into a digital signal and generate a digital signal. As the A/D converter 120, a typical A/D converter mounted on most Micro Controller Units (MCUs) may be used without needing to be additionally configured. Of course, the A/D converter 120 may be implemented as an independently provided A/D converter. Through the digital conversion procedure for the variation signal, a precise comparison may be more easily performed in a comparison procedure to be performed by the comparison unit 130 which will be described later. Accordingly, an error rate that may be caused by each device due to analog signals may be reduced, and more precise results may be obtained.

The threshold level setting unit 140 functions to variably set at least one changeable threshold level. Here, the threshold level setting unit 140 may set the changeable threshold level through a Digital Addressable Lighting Interface (DALI) or at least one lighting control network interface. Here, when the DALI is used, an operation voltage for the DALI is taken from a DALI bus. Therefore, the DALI may be designed to be used together with DALI components. By means of this, it is possible to adjust the detection area of the motion sensor in a field environment.

Here, the threshold level may be stored in a separate storage unit and may be called and set through the DALI. Here, various threshold levels may be stored in the separate storage unit in the form of threshold level tables via a plurality of experiments. In this case, the threshold level setting unit 140 may receive and set threshold levels through central control on the DALI. Here, in the case of the threshold level tables, various tables corresponding to the external environment, such as day or night, cloudy or clear day, and external temperature, may be timely received. Based on this configuration, for respective motion sensors 100 of the present invention to be installed in a building, threshold level tables may be received and used through the DALI without being separately generated. Using the tables, a threshold level may be individually set for each motion sensor 100 according to the present invention, and threshold levels may be set at one time via central control.

Further, the threshold level setting unit 140 may set two or more threshold levels so that the error rate is less than a preset value. That is, detection sensitivity increases as a threshold level decreases, whereas it decreases as the threshold level increases. Due to these characteristics, the size of the detection area may be changed depending on the threshold sensitivity corresponding to the changeable threshold level. In detail, the range of the detection area is widened as the threshold sensitivity increases, whereas it is narrowed as the threshold sensitivity decreases. Here, as the threshold sensitivity increases, malfunction caused by erroneous detection may occur, and thus two or more threshold levels may be set so that the error rate is less than the preset value.

The comparison unit 130 functions to detect motion by performing a comparison operation based on the changeable threshold level and the variation signal at the threshold sensitivity corresponding to the changeable threshold level set by the threshold level setting unit 140. In this case, the comparison unit 130 may compare the digital signal generated by the A/D converter 120 with the changeable threshold level in a digital manner. Accordingly, if the intensity corresponding to the digital signal is included in the range of the changeable threshold level, the current state is determined to be a motion detection state. Otherwise, the current state is determined to be a motion non-detection state.

FIG. 2 is a diagram showing an example in which detection areas are adjusted based on a changeable threshold level according to the motion sensor of the present invention. Referring to FIG. 2, an example in which the motion sensor 200 of the present invention is installed on the ceiling of an indoor space is described. In the description of FIG. 2, a case where the motion sensor 200 has two threshold levels is assumed. In this case, two (multiple) threshold levels are set such that an error rate is less than a preset value. Further, it should be understood that the number of threshold levels is given for help of understanding this invention, and is not limited by the present embodiment. In FIG. 2, a detection area for a first threshold level is represented by r4. Further, a detection area for a second threshold level is represented by r2. That is, the detection area for the first threshold level is represented by a threshold range from P1 to P4, and the detection area for the second threshold level is represented by a threshold range from P2 to P3. That is, it should be understood that when the detection target falls out of the threshold ranges for the respective threshold levels, the detection target is not detected. When the threshold level is set to the first threshold value by the threshold level setting unit 140, a detection area for the detection target is set to r4. Further, when the threshold level is set to the second threshold value by the threshold level setting unit 140, a detection area for the detection target is set to r2.

When the detection target falls within any one of area r1, area r2, and area r3, the detection unit of the motion sensor 200 according to the present invention detects the detection target based on the threshold level. That is, in the present example, in the detection area r4 set based on the first threshold value, the detection target may be detected regardless of whether the detection target is present in any of the detection areas r1, r2, and r3. However, when the threshold level is set based on the second threshold value, the detection target is detected only in the detection area r2.

Further, when the threshold level is set based on the first threshold value, it is determined that the detection target has been detected in all of the areas r1 to r3. However, when the threshold level is set based on the second threshold value, it is determined that the detection target has been detected only in the area r2. Due to these characteristics, the threshold level may be variably adjusted from the threshold level generated based on the first threshold value to the threshold level generated based on the second threshold value, thus decreasing detection sensitivity and narrowing the detection area. Owing to this function, the error rate may be decreased.

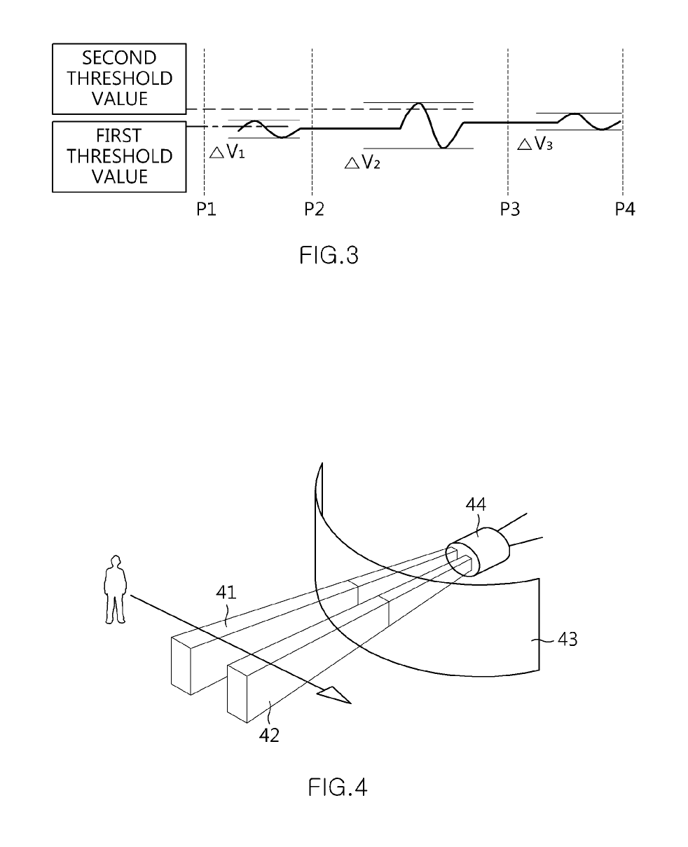

FIG. 3 is a diagram showing an example of a variation signal output from the detection unit depending on the example of FIG. 2. Referring to FIG. 3, the example of the variation signal output from the detection unit when motion is detected by the detection unit of the motion sensor according to the present invention is illustrated. In this case, ΔV_{'}, ΔV₂, and ΔV₃ denote examples of a variation signal output when motion is detected in any one of the areas r1, r2, and r3 of FIG. 2. For the help of understanding the variation signal in the graph shown in FIG. 3, the outputs generated when a detection target is individually detected in area r1, area r2, and area r3 are shown as being indicated together on a single line. However, it should be understood that only a single variation signal is output on a single line.

As shown in FIG. 3, the magnitude, that is, intensity, of the variation signal may vary according to the distance between the motion sensor according to the present invention and the detection target. That is, as the distance between the motion sensor and the detection target becomes shorter, the intensity of the variation signal becomes larger. In contrast, as the distance between the motion sensor and the detection target becomes longer, the intensity of the variation signal becomes smaller. By utilizing the characteristics of the motion sensor according to the present invention, the distance between the detection target and the motion sensor may be estimated.

FIG. 4 is a diagram showing an example in which the motion sensor according to the present invention generates detection areas. As shown in FIG. 4, when the motion sensor according to the present invention generates detection areas, two areas, that is, a first detection area 41 and a second detection area 42, may be mainly generated. That is, the motion sensor may generate two detection areas as shown in the present example, based on a PIR (Pyroelectric Infrared or Passive Infrared) sensor for detecting motion using a preset number of slots. In this case, since the number of slots that are mounted may be one or more, the number of detection areas that are generated may also be one or more. In the present example, when a detection target moves in the direction of an arrow shown in FIG. 4, the detection target sequentially passes through the first detection area 41 and the second detection area 42. Here, both the slot required to generate the first detection area 41 and the slot required to generate the second detection area 42 may be either “+” shaped slots or “−” shaped slots. Of course, the slot required to generate the first detection area 41 may be mounted as a “+” shaped slot, and the slot required to generate the second detection area 42 may be mounted as a “−” shaped slot. In contrast, the slot required to generate the first detection area 41 may be mounted as a “−” shaped slot, and the slot required to generate the second detection area 42 may be mounted as a “+” shaped slot. Here, the “+” shaped slot is configured to output the variation signal as a rising signal, and the “−” shaped slot is configured to output the variation signal as a falling signal. Accordingly, when the detection target passes through the first detection area 41 and the second detection area 42, motion is detected in the detection areas 41 and 42. The direction of the motion of the detection target may also be recognized due to the characteristics of the variation signal corresponding to the motion. More exactly, it may be determined whether the detection target falls within the corresponding detection area of the sensor or falls out of the detection area.

Further, in FIG. 4, a Fresnel lens 43 may help the detection areas be generated. The Fresnel lens 43 is made of a material transmitting infrared rays sensitive to emission from the detection target.

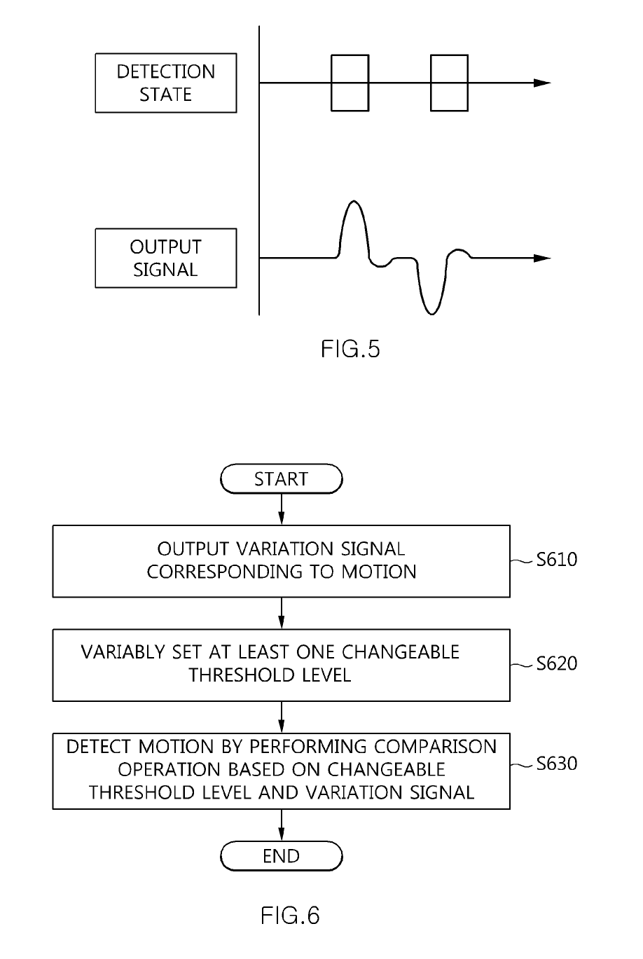

FIG. 5 is a diagram showing an example of a variation signal output when a detection target is detected in detection areas generated by the motion sensor according to the present invention. That is, FIG. 5 illustrates an example of a variation signal when the first detection area is formed through a “+” shaped slot and the second detection area is formed through a “−” shaped slot in the example of FIG. 4.

That is, when the detection target passes by the second detection area through the first detection area, the variation signal for the first detection area exhibits a rising shape, and the variation signal for the second detection area exhibits a falling shape. Further, when the detection target passes by the first detection area through the second detection area, the forms of the variation signal may be contrary to those of the above case.

FIG. 6 is a flowchart showing a method of operating a motion sensor according to an embodiment of the present invention. In the following description, a detailed description of repeated portions identical to the above-described components will be omitted for the simplicity of the present specification.

First, at step S610, a variation signal corresponding to motion is output by the detection unit. That is, as described above with reference to FIG. 1, step S610 is configured to detect motion when motion is detected in a detection area. Here, the detection of motion may be performed based on a variation in temperature in the detection area. Further, the detection of motion may be performed by sensing infrared rays emitted from the detection target in the detection area. Thereafter, the variation signal corresponding to the detected motion is output.

Thereafter, at step S620, at least one changeable threshold level is variably set by the threshold level setting unit. As described above, as the threshold level decreases, detection sensitivity increases, whereas as the threshold level increases, detection sensitivity decreases. Due to this fact, the size of the detection area may be varied depending on the threshold sensitivity. In detail, as the threshold sensitivity increases, the range of the detection area is widened, whereas as the threshold sensitivity decreases, the range of the detection area is narrowed.

Further, at step S620, the changeable threshold level may be set through a DALI or at least one lighting control network interface. In this case, if the DALI is used, an operation voltage for the DALI is taken from a DALI bus. Therefore, the DALI may be designed to be used together with DALI components.

Further, at step S620, a threshold level table stored in a separate storage unit may be called and then the changeable threshold level may be set. By means of this, as described above, respective threshold levels for motion sensors in a single building may be set at one time via central control based on the DALI.

Furthermore, at step S620, two or more threshold levels may be set such that the error rate is less than a preset value. Details related to the above-described step S620 have been described above with reference to FIGS. 1 and 2, and thus a detailed description thereof will be omitted.

Thereafter, at step S630, a comparison operation based on the changeable threshold level and the variation signal is performed by the comparison unit at threshold sensitivity corresponding to the changeable threshold level, and thus motion is detected.

Furthermore, although not shown in detail, the method of operating the motion sensor according to the present invention may further include, after step S610, the step of synchronizing the OFF period of the duty cycle of a PWM signal from an LED light source with the detection cycle of the present invention. By means of this synchronization step, overlapping interference between lighting communication, which can be performed using the LED light source, and the detection cycle of the present invention may be prevented.

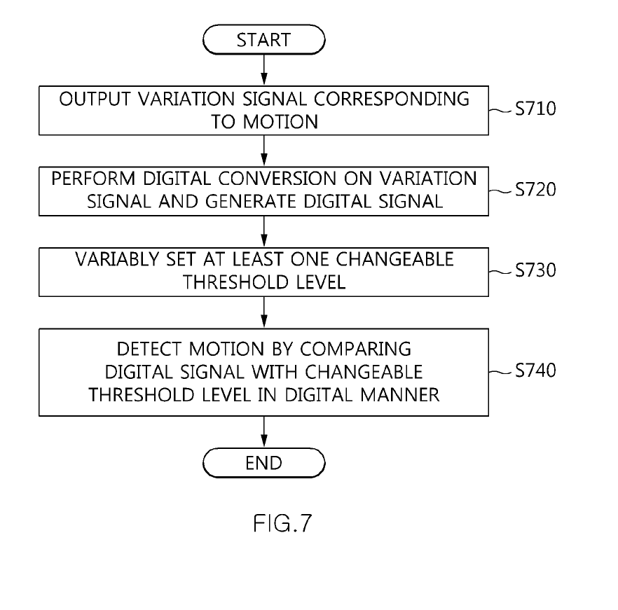

FIG. 7 is a flowchart showing a method of operating the motion sensor according to another embodiment of the present invention. In the following description, a description of details described above with reference to FIG. 6 will be omitted for the simplicity of the present specification.

First, at step S710, a variation signal corresponding to motion is output by the detection unit.

Thereafter, at step S720, digital conversion is performed on the variation signal and a digital signal is generated by an A/D converter. Here, as the A/D converter, a typical A/D converter included in most MCUs may be used without needing to be separately added. Alternatively, the A/D converter may be implemented as an independently provided A/D converter. By means of this digital conversion procedure, more precise detection results may be obtained.

Thereafter, at step S730, at least one changeable threshold level is set by the threshold level setting unit. As described above, step S730 may be configured to set the changeable threshold level through a DALI or at least one lighting control network interface. Further, step S730 may be configured to call a threshold level table stored in a separate storage unit and to variably set the threshold level. Furthermore, step S730 may be configured to set two or more threshold levels such that the error rate is less than a preset value. Since details of the above-described step S730 have been described in detail with reference to FIGS. 1, 2, and 6, a detailed description thereof will be omitted here.

Thereafter, at step S740, the digital signal is compared with the changeable threshold level by the comparison unit in a digital manner at threshold sensitivity corresponding to the changeable threshold level, and thus motion is detected.

In addition, as described above with reference to FIG. 6, the method of operating the motion sensor according to the present invention may further include, after step S610, the step of synchronizing the OFF period of the duty cycle of a PWM signal from an LED light source with the detection cycle of the present invention. As described above, through this synchronization step, even if the motion sensor of the present invention is combined with the LED light source, they may be normally operated without negatively influencing each other.

In accordance with the motion sensor of the present invention, detection areas in which a target can be detected by the motion sensor can be freely adjusted.

Further, the motion sensor according to the present invention is advantageous in that a variation signal occurring upon detecting motion is converted into a digital signal and a changeable threshold level is set, thus reducing an error rate that may occur in the motion sensor.

Furthermore, the motion sensor according to the present invention is advantageous in that the direction of the motion of a detection target can be sensed.

Furthermore, the motion sensor according to the present invention is advantageous in that the motion sensor can be located in an LED light source by synchronizing the OFF period of the duty cycle of a PWM signal from the LED light source with the detection cycle of the motion sensor of the present invention.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Accordingly, those skilled in the art will appreciate that various modifications and other equivalent embodiments are possible from the embodiments. Therefore, the technical scope of the present invention should be defined by the technical spirit of the claims.

What is claimed is:

1. A motion sensor comprising:
a detection unit for outputting a variation signal corresponding to motion;
a threshold level setting unit for variably setting at least one changeable threshold level; and
a comparison unit for detecting the motion by performing a comparison operation based on the changeable threshold level and the variation signal at threshold sensitivity corresponding to the changeable threshold level.

2. The motion sensor of claim 1, wherein the motion sensor has a detection area varying depending on the threshold sensitivity.

3. The motion sensor of claim 2, wherein the detection area is widened as the threshold sensitivity increases, whereas the detection area is narrowed as the threshold sensitivity decreases.

4. The motion sensor of claim 3, wherein the threshold level setting unit sets two or more threshold levels so that an error rate is less than a preset value.

5. The motion sensor of claim 4, wherein the comparison unit performs digital conversion on the variation signal, generates a digital signal, and compares the digital signal with the changeable threshold level in a digital manner.

6. The motion sensor of claim 5, wherein the digital conversion is performed by an Analog to Digital (A/D) converter included in a Micro Controller Unit (MCU) or by an independent A/D converter.

7. The motion sensor of claim 6, wherein the threshold level setting unit sets the changeable threshold level through a Digital Addressable Lighting Interface (DALI) or at least one lighting control network interface.

8. The motion sensor of claim 7, wherein the motion sensor has a detection cycle synchronized with an OFF period of a duty cycle of a Pulse Width Modulation (PWM) signal from a Light Emitting Diode (LED) light source.

9. A method of operating a motion sensor, comprising:
outputting, by a detection unit, a variation signal corresponding to motion;
variably setting, by a threshold level setting unit, at least one changeable threshold level; and
detecting, by a comparison unit, the motion by performing a comparison operation based on the changeable threshold level and the variation signal at threshold sensitivity corresponding to the changeable threshold level.

10. The method of claim 9, wherein a detection area varies depending on the threshold sensitivity.

11. The method of claim 10, wherein the detection area is widened as the threshold sensitivity increases, whereas the detection area is narrowed as the threshold sensitivity decreases.

12. The method of claim 11, wherein variably setting the at least one changeable threshold level is configured to set two or more threshold levels so that an error rate is less than a preset value.

13. The method of claim 12, further comprising, after outputting the variation signal, performing digital conversion on the variation signal and generating a digital signal through an A/D converter, wherein detecting the motion is configured to compare the digital signal with the changeable threshold level in a digital manner, thus detecting the motion.

14. The method of claim 13, wherein the digital conversion is performed by an A/D converter included in a Micro Controller Unit (MCU) or by an independently provided A/D converter.

15. The method of claim 14, wherein variably setting the at least one changeable threshold level is configured to set the changeable threshold level through a Digital Addressable Lighting Interface (DALI) or at least one lighting control network interface.

16. The method of claim 15, wherein the motion sensor has a detection cycle synchronized with an OFF period of a duty cycle of a Pulse Width Modulation (PWM) signal from a Light Emitting Diode (LED) light source.
